(19) United States
(12) Patent Application Publication
(10) Pub. No.: US 2005/0033977 A1
(43) Pub. Date: Feb. 10, 2005

(54) Method for validating a system

(76) Inventors: Victor Zurita, Woodbridge (CA); Antonietta Del Medico, Toronto (CA); Suresh Balan, Brampton (CA)

Correspondence Address: PATENT ADMINSTRATOR;KATTEN MUCHIN ZAVIS ROSENMAN, 525 WEST MONROE STREET, SUITE 1600, CHICAGO, IL, 60661-3693, US

(21) Appl. No.: 10/635,003

(22) Filed: Aug. 6, 2003

(51) Int. Cl. G06F 11/30

(52) U.S. Cl. 713/200

(57) ABSTRACT

The present invention provides a novel method for validating computer systems, in particular for validating computer systems for use in the healthcare industry. The method is computer based, and in at least one embodiment includes steps of gathering information about project for a particular computer system, generating a validation plan for that system, including a plurality of tests to be conducted on the system. The method also includes a steps for presenting the tests and gathering responses, and organizing and presenting an overall report regarding the success or failure of those tests.

### FIELD OF THE INVENTION

The present invention relates generally to computing systems and more particularly to a method for validating a system such as a computing system or the like.

### BACKGROUND OF THE INVENTION

Automation has greatly improved industrial and office productivity. Today, computer systems represent one of the most significant features of automation. Computer systems, implemented using different computing environments, are involved in the operation of almost all facets of industrial and office automation. As used herein, the term “computing environment” denotes the plurality of components used in a particular computing system. Such components can include particular computing hardware (i.e. CPU, motherboard, memory, network interfaces, hard disc storage, etc) and/or operating systems and/or compilers and/or other hardware components and/or other software components.

Many examples of automation effected through computing systems can be found. In the industrial environment, programmable logic controllers or PLCs run robots and other equipment to effect production and assembly in a very precise and efficient manner. In the office environment, computers are used to produce documents, and manage accounting, sales and distribution.

One particular industry that is highly automated through computing systems is the pharmaceutical industry. While each industry has its own unique needs for particular types of computing systems, the needs of the pharmaceutical industry can stand on their own. More specifically, patient safety is paramount, and accordingly, very strict quality control is required to ensure that the pharmaceuticals being produced comply with the exact specifications of the product monograph as approved by local regulatory authorities, such as the Food and Drug Administration (“FDA”) in the USA. The needs of the pharmaceutical industry can be found in other industries, such as the health care industry in general.

Thus, an important element to ensuring patient safety through quality control is to utilize a vigorous validation process for all computing systems that are used in the healthcare industry. Indeed, those of skill in the art recognize that the promulgation of industry standards and government regulations, in particular 21 CFR Part 11 in the U.S.A., represent a very significant hurdle to be achieved in the validation process for computing systems, processes and the like used in the healthcare industry.

Current validation procedures used in the healthcare industry are manual in nature and extremely time consuming and laborious. Further, since the entire process is subject to an audit by government authorities, copious records must be collected and coherently presented when such audits occur. In addition, 21 CFR Part 11 has introduced a set of rigid statutory requirements that nonetheless can be subject to a broad range of interpretation. The end result is that prior art validation procedures are ad hoc, expensive, and time consuming. Finding individuals qualified to perform such manual validation is very difficult, and training programs for these individuals are few and far between. Even with qualified personnel to conduct the verification procedure, it is not uncommon for a healthcare manufacturer to spend up to a year validating one computing system. Similar delays and problems occur during validations of other types of systems and processes used by the healthcare industry.

### SUMMARY OF THE INVENTION

It is an object of the present invention to provide a novel method for validating a computing system that obviates or mitigates at least one of the above-identified disadvantages of the prior art.

A first aspect of the invention provides a computer-implemented method of validating a computer system comprising the steps of:
(i) receiving data representative of a plurality of requirements for the computer system;
(ii) generating a validation plan based on the received data;
(iii) determining a computing environment appropriate to the computer system based on the received data;
(iv) generating a plurality of tests to be performed during an implementation of the validation plan;
(v) presenting the tests to a user as part of the implementation;
(vi) receiving responses from the user as to a status of the tests;
(vii) generating a validation report based on the responses;
(viii) presenting a first message if the validation report indicates the system failed one or more of the tests;
(ix) presenting a second message if the validation report indicates the system meets the tests; and,
(x) repeating one or more of the foregoing steps until the validation report indicates the system meets the tests.

A second aspect of the invention comprises a computer-implemented method of validating a computer system comprising the steps of:
receiving a plurality of validation requirements for the computer system;
receiving data representative of the results of performing each validation requirement, the results including whether a particular requirement was achieved and exception reports for each requirement that was not achieved; and,
generating a report for each of the requirements, the report including a message indicating whether the system is validated if a defined set of the requirements are achieved.

In a particular implementation, the computer system is used in the pharmaceutical industry, or a computer system used in the health care industry. The validation requirements include at least one of the following: installation qualification, operational qualification, performance qualification, a third-party qualification.

The third-party qualification can be based on 21 CFR Part 11.

The installation qualification, the operational qualification, the performance qualification, and the third-party qualification can each include at least one of a user requirement, a test objective, and a test instruction.

The validation requirement(s) can further include an audit respective to the installation qualification, the operational qualification, the performance qualification, and the third-party qualification. The audit is typically comprised of a predefined checklist reflecting best practices applicable to an identifiable type of the system.

The report can indicate that the requirements are not achieved unless an affirmative response that each requirement was achieved has been received.

The method can comprise the additional step of presenting a report summarizing each of the requirements.

Another aspect of the invention provides an apparatus for validating a computer system comprising an input means for receiving a plurality of validation requirements for the computer system. The input means is additionally for receiving data representative of the results of performing each validation requirement. The results include whether a particular requirement was achieved and exception reports for each requirement that was not achieved. The apparatus further comprises a processing means for generating a report for each of the requirements, the report including a message indicating whether the system is validated if a defined set of the requirements are achieved.

### BRIEF DESCRIPTION OF THE DRAWINGS

The present invention will now be explained, by way of example only, with reference to certain embodiments and the attached Figures in which:

FIG. 1 is a schematic representation of an apparatus for validating a computing system in accordance with an embodiment of the invention;

FIG. 2 is a flowchart representing a method of validating a computer system in accordance with another embodiment of the invention;

FIG. 3 is a schematic representation of an exemplary computer system that can be validated using embodiments of the present invention;

FIG. 4 is a screen-shot that can be presented during performance of the method in FIG. 2;

FIG. 5 is another screen-shot that can be presented during performance of the method in FIG. 2;

FIG. 6 is another screen-shot that can be presented during performance of the method in FIG. 2;

FIG. 7 is another screen-shot that can be presented during performance of the method in FIG. 2;

FIG. 8 is a flowchart representing a set of sub-steps that can be performed to effect certain steps in the method of FIG. 2;

FIG. 9 is another screen-shot that can be presented during performance of the method in FIG. 2;

FIG. 10 is another screen-shot that can be presented during performance of the method in FIG. 2;

FIG. 11 is a flowchart representing a set of sub-steps that can be performed to effect certain steps in the method of FIG. 2;

FIG. 12 is a flowchart representing a set of sub-steps that can be performed to effect certain steps in the method of FIG. 2;

FIG. 13 is a flowchart representing a set of sub-steps that can be performed to effect certain steps in the method of FIG. 2;

FIG. 14 is a flowchart representing a set of sub-steps that can be performed to effect certain steps in the method of FIG. 2; and,

FIG. 15 is a flowchart representing a method of validating a computer system in accordance with another embodiment of the invention.

### DESCRIPTION OF THE INVENTION

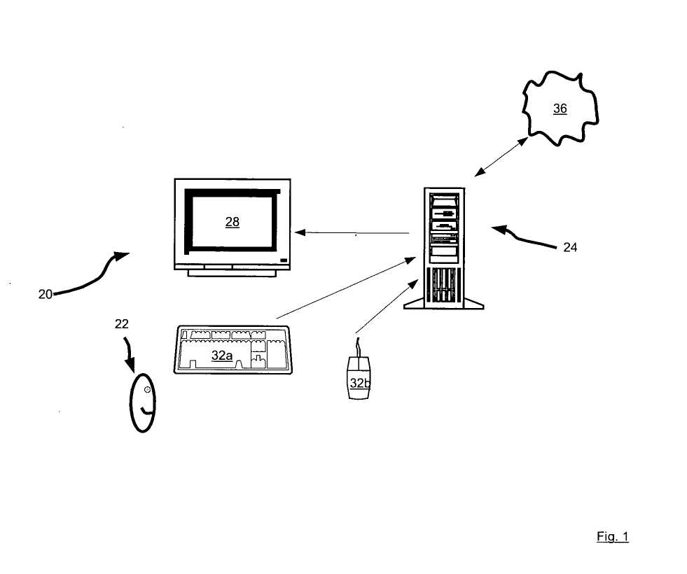

Referring now to FIG. 1, an apparatus for validating a computing system is indicated generally at 20. In the present embodiment, apparatus 20 is a desktop computer, but can be a server, client, terminal, personal digital assistant or any other computing device. Apparatus 20 comprises a tower 24, connected to an output device 28 for presenting output to a user and one or more input devices 32 for receiving input from a user. Tower 24 typically houses at least one central processing unit (“CPUs”) coupled to random access memory and permanent storage devices via a bus. In the present embodiment, output device 28 is a monitor, and input devices 32 include a keyboard 32a and a mouse 32b. Other output device and input devices will occur to those of skill in the art. In the present embodiment, tower 24 also includes a network interface card and connects to a network 36, which can be the intranet, internet or any other type of network for interconnecting a plurality of computers, as desired.

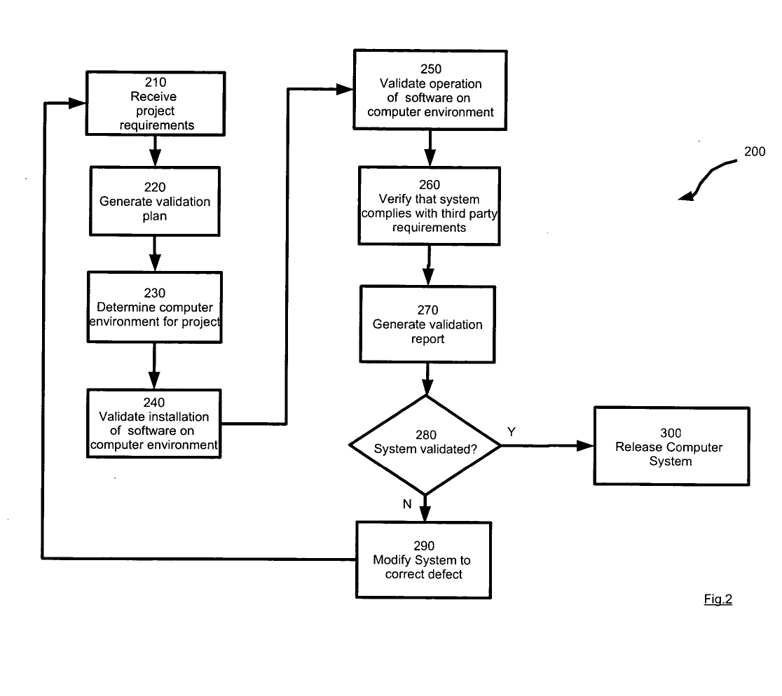

Referring now to FIG. 2, a method for validating a computing system is indicated generally at 200. In order to assist in the explanation of the method, it will be assumed that the method in FIG. 2 is operated using apparatus 20. Furthermore, the following discussion of method 200 will lead to further understanding of apparatus 20. (However, it is to be understood that apparatus 20 and/or the method of FIG. 2 can be varied, and need not work exactly as discussed herein in conjunction with each other, and that such variations are within the scope of the present invention.)

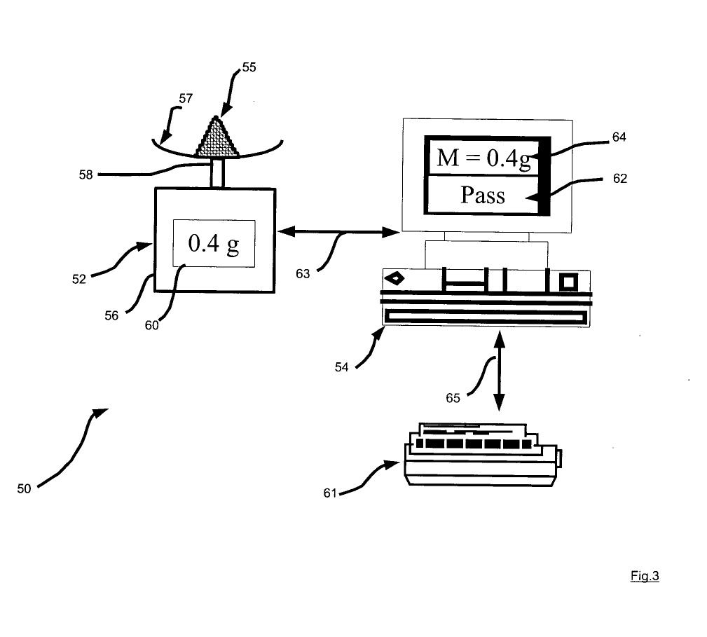

Before discussing method 200 further, an example of a computer system that can be validated using apparatus 20 and method 200 will be proposed and used hereafter in conjunction with the explanation of method 200. Referring now to FIG. 3, an example computer system is indicated generally at 50. System 50 is comprised of a set of scales 52 and a workstation 54. Scales 52 includes a tray 57 for receiving a pharmaceutical ingredient 55. Tray 57 is mechanically connected to a body 56 via a piston 58 that houses a transducer and electronic circuitry. The transducer is operable to generate an electrical signal proportionate to the distance that piston 58 is urged towards body 56 due to the weight of pharmaceutical ingredient 55 on tray 57. The electronic circuitry in turn is operable to generate a number, expressed in grams, that reflects the mass of pharmaceutical ingredient 55. Body 56 thus also includes a display 60, which is also connected to the electronic circuitry in order to present the determined weight of pharmaceutical ingredient 55.

The electronic circuitry in body 56 also includes a Universal Serial Bus (“USB”) port mounted on the exterior of body 56 and which is connected to a corresponding USB port on workstation 54 via a USB cable 63. The USB connection is operable to deliver the mass measurement of pharmaceutical ingredient 55 generated by the electronic signal to workstation 54. In turn, workstation 54 executes a software package, which is referred to herein as “WeightMate”, that monitors the mass measurement readings received at its USB port. The “WeightMate” software in workstation 54 is also operable to present a split screen of data. A bottom half 62 of the screen indicates whether the mass measurement is within an acceptable tolerance—and presents a “Pass” or “Fail” message according to whether the mass measurement meets that tolerance. A top half 64 of the screen presents the mass measurement. In FIG. 3, bottom half 62 is shown presenting a “Pass” message, while top half 64 presents the message “0.4 g”, collectively indicating that the 0.4 g mass measurement is within the accepted tolerance of mass for pharmaceutical ingredient 55. In this manner, a user of system 50 can determine that the quantity of pharmaceutical ingredient 55 in tray 57 is acceptable for combining with inactive ingredients to manufacture a tablet, where the amount of active ingredient required is 0.4 g. “WeightMate” is able to authenticate and record the identity of a given user of system 50, and to record the various passes or fails, and associated measurements, that occur during a period while that user is authenticated, and to create electronic records bearing a digital signature of that user so that the records can be later authenticated.

In addition to the foregoing, FIG. 3 also shows a printer 61 connected to workstation 54 via a second USB connection 65. Workstation 54 includes a USB printer driver. Printer 61 will be discussed in greater detail below.

Thus, system 50 can be summarized into a number of parameters, and which are listed in Table I.

TABLE I
Parameters of System 50

| Component | Paramater | Comment |
|---|---|---|
| Scale 52 | Transducer accurate to 1/10 of | |
| | a gram | |
| Scale 52 | Display able to show up to | Display corresponds to to |
| | 1/10 of a gram | transducer measurement |
| Scale 52 | USB port output from | Complies with USB |
| | transducer | standard |
| Workstation 54 | Intel ™ P-4 Processor | |
| Workstation 54 | 256 MB RAM | |
| Workstation 54 | 10 GB Hard drive | |
| Workstation 54 | USB port | |
| Workstation 54 | Windows 2000 ™ OS | |
| Workstation 54 | USB Driver for Scale 52 | Driver that is written by |
| | | manufacturer of scale 52 |
| Workstation 54 | USB Driver for printer 61 | Driver included with |
| | | Windows 2000 ™ OS. |
| Printer 61 | Line printer connected by | |
| | USB cable to workstation 54 | |
| “WeightMate” | Executes on computer | Software package for use |
| software | platform with workstation 54 | with scale 52 and written |
| | specifications | by manufacturer of scale |
| | | 52 |
| “WeightMate” | Communicates accurately | |
| software | with USB driver for scale 52 | |
| “WeightMate” | Displays mass in top half of | |
| software | screen | |
| “WeightMate” | User can configure tolerance | |
| software | ranges for “Pass” and “Fail” | |
| “WeightMate” | Keeps logs of “Pass”, “Fail” | |
| software | and masses for a given user | |
| “WeightMate” | Attaches digital signature of | |
| software | each user for each log | |

Returning now to method 200 in FIG. 2, beginning at step 210, the requirements for a project for a new computer system is received at apparatus 20. The requirements are received using input devices 32a and/or 32b, and/or by downloading data from network 36, or using any other desired means. At this step, it will be assumed that a user 22 of apparatus 20 performing method 200 will have identified that a) a product such as system 50 is needed and b) system 50 is an off-the-shelf solution that may be suitable. However, before system 50 can be used, it is to be validated using apparatus 20 and method 200.

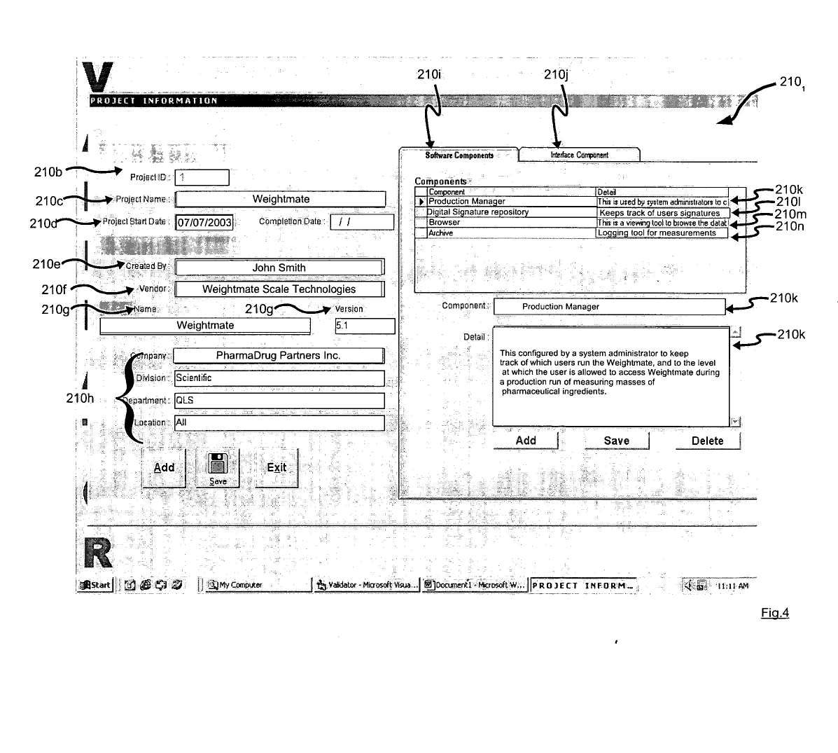

Accordingly, at step 210, a user 22 of apparatus 20 will enter data into apparatus 20. FIG. 4 shows an example of a screen 210₁ that user 22 is presented with, to prompt user 22 to enter the data to be received at step 210. Table II shows a list of fields of data that will be completed by user 22.

TABLE II
Step 210
“Project Overview”

| Reference | | | |
|---|---|---|---|
| Number | Field | Description | Comment |
| 210b | Project ID | Unique identifier for a | A new identifier is created for |
| | | given project | each computer system that is |
| | | | being validated, and is |
| | | | identified with a project |
| | | | number. This identifier may |
| | | | or may not be visible to the |
| | | | user 22. |
| 210c | Project Name | Text based name to | |
| | | identify the project | |
| 210d | Project Start Date | Date that actual project is | |
| | | commenced | |
| 210e | Created by | Name or UserID of user | |
| | | 22 | |
| 210f | Vendor | Name of Vendor | In this case, Vendor is |
| | | supplying computer | “Weightmate Scale |
| | | system. | Technologies” is the |
| | | | prospective vendor of |
| | | | computer system 50. |
| | | | Could be limited to the name |
| | | | of a vendor supplying a major |
| | | | component of system. For |
| | | | example, could be simply the |
| | | | name of software vendor |
| | | | where existing computer |
| | | | equipment is being used. |
| 210g | Name/Version | Trademark used to | In this case, the product name |
| | | identify name of project | “Weightmate” is identified |
| | | being sold by Vendor. | here. |
| | | Version of software is | Where component is software |
| | | also identified. | only, then this field would |
| | | | only identify the name of the |
| | | | software vendor. |
| 210h | Company/Division/ | A unique identifier for | |
| | Department/Location | the entity that owns or | |
| | | will own the computer | |
| | | system being validated. | |
| | | Can be as little as one | |
| | | field, or more can be | |
| | | used where a large | |
| | | organization is involved | |
| 210i | Software | Database that identifies | |
| | Components | the specific software | |
| | | components in computer | |
| | | system 50. | |
| 210k | Software Component | The “Production | This is an example of a |
| | | Manager” component of | software component 210i, |
| | | Weightmate | which is always respective to |
| | | | the particular computer |
| | | | system 50 being validated. In |
| | | | this case, the “Production |
| | | | Manager” is configured by a |
| | | | system administrator to keep |
| | | | track of which users run |
| | | | system 50, and to at level they |
| | | | are allowed to access system |
| | | | 50 during a production run of |
| | | | measuring masses of |
| | | | pharmaceutical ingredients |
| | | | 55. |
| 210l | Software Component | Digital Signature | Another example of a |
| | | repository | software component 210i. In |
| | | | this case, the “Digital |
| | | | Signature repository” is |
| | | | configured by a system |
| | | | administrator to keep track of |
| | | | the digital signatures of each |
| | | | user that runs system 50. The |
| | | | signatures are attached to a |
| | | | log generated during |
| | | | production run of measuring |
| | | | masses of pharmaceutical |
| | | | ingredients 55. |
| 210m | Software Component | Browser | Another example of a |
| | | | software component 210i. In |
| | | | this case, the “Browser” |
| | | | allows an authorized user to |
| | | | review logs generated during |
| | | | production run of measuring |
| | | | masses of pharmaceutical |
| | | | ingredients 55. |
| 210n | Software Component | Archive | Another example of a |
| | | | software component 210i. In |
| | | | this case, the “Archive” is a |
| | | | repository of all logs |
| | | | generated during production |
| | | | runs of measuring masses of |
| | | | pharmaceutical ingredients |
| | | | 55, including the digital |
| | | | signatures attached to those |
| | | | logs. |
| 210j | Interface | Database that identifies | Similar to the software |
| | Components | specific interfaces in | components 210i, this |
| | | computer system 50. | database will include a list of |
| | | | other software components |
| | | | for system 50 and to software |
| | | | components 210i must |
| | | | communicate. For example, |
| | | | where “Weightmate” must be |
| | | | able to export logs in Excel |
| | | | Format, then this interface |
| | | | component would be required. |

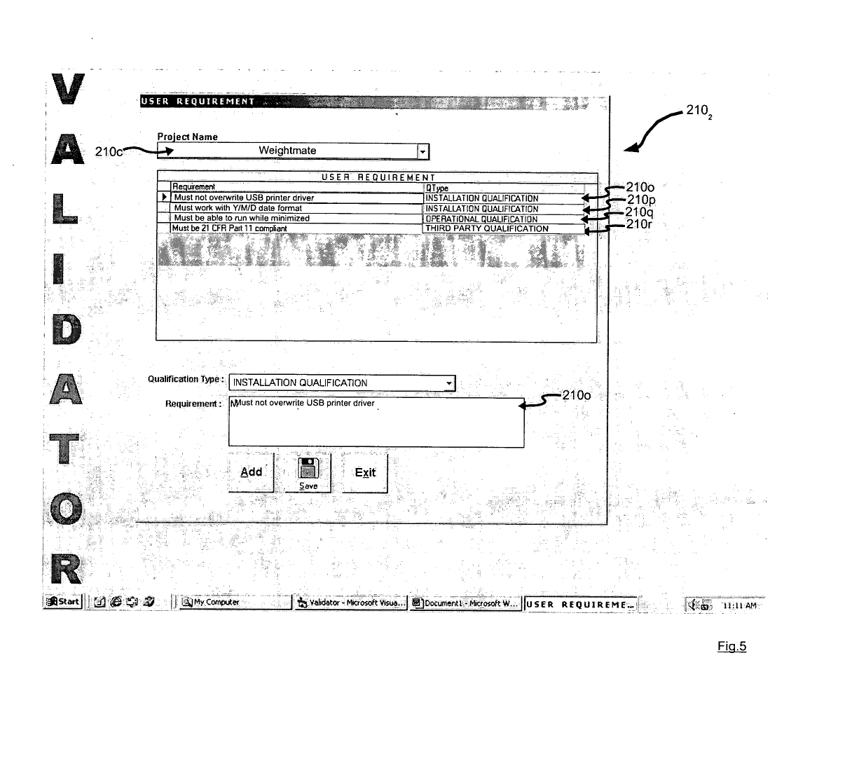

Having completed the information in Table II, user 22 will continue to enter in data relevant to step 210. FIG. 5 shows an example of a screen 210₂ that user 22 is presented with, to prompt user 22 to enter further data to be received at step 210. In this case, FIG. 5 reflects a set of user requirements to be entered. Table III mirrors the example in FIG. 5, providing further explanation thereof.

TABLE III
Step 210
“User Requirements”

| Reference | | | |
|---|---|---|---|
| Num | Requirement Type | Description | Comment |
| 210o | Installation | Data entry field for user | Any type of installation |
| | Qualification | to enter a specific | criteria that has been identified |
| | | installation requirement | as part of the requirements to |
| | | that is needed in order to | validate a system can be |
| | | validate computer | entered here. |
| | | system 50. | In this example, this field has |
| | | | had the data “Must not |
| | | | overwrite USB printer driver” |
| | | | entered. This is, for example, |
| | | | to ensure that the USB |
| | | | interface that talks to scale 52 |
| | | | does not interfere with a USB |
| | | | printer driver interface in the |
| | | | event a USB printer is |
| | | | connected to workstation 54. |
| 210p | Installation | Data entry field for user | Any type of installation |
| | Qualification | to enter a specific | criteria that has been identified |
| | | installation requirement | as part of the requirements to |
| | | that is needed in order to | validate a system can be |
| | | validate computer | entered here. |
| | | system 50. | In this example, this field has |
| | | | had the data “Must be |
| | | | compatible with Y/M/D |
| | | | format” entered. This is, for |
| | | | example, to ensure that |
| | | | Weightmate can operate in the |
| | | | Y/M/D format, with the |
| | | | assumption that Pharmadrug |
| | | | Partners Inc., the purchaser, |
| | | | requires that all of its computer |
| | | | systems are set to this format. |
| 210q | Operation | Data entry field for user | Any type of criteria that has |
| | Qualification | to enter specific | been identified as part of the |
| | | operation requirement | operational requirements to |
| | | that is needed in order to | validate a system can be |
| | | validate computer | entered here. |
| | | system 50. | In this example, this field has |
| | | | had the data “Must be able to |
| | | | run while minimized” entered. |
| | | | This is, for example, to ensure |
| | | | that Weightmate will continue |
| | | | to operate when it is |
| | | | minimized so that the user can |
| | | | open another application |
| | | | workstation 54. |
| 210r | Third Party | Data entry field for user | Any type of criteria that has |
| | Qualification | to enter specific third | been identified as part of the |
| | | party requirement that is | third party requirement to |
| | | needed in order to | validate a system can be |
| | | validate computer | entered here. |
| | | system 50. | In this example, this field has |
| | | | had the data “Must be 21 CFR |
| | | | Part 11 compliant” entered. |
| | | | This is, for example, to ensure |
| | | | that Weightmate will meet |
| | | | government requirements for |
| | | | tracking digital signatures on |
| | | | logs, as required by 21 CFR |
| | | | Part 11. |

In the foregoing Table III, it will be noted that installation qualifications operational qualifications and third party qualifications were shown as examples. If desired, method 200 can be modified to include other types of qualification criteria, such as performance qualifications, that relate to how well computer system 50 operates. Other types of criteria can also be included, as desired.

Further information entered at step 210 using appropriate interfaces can include detailed descriptions of various types of standardized procedures to be followed when performing a particular type of qualification. Thus, for example, when performing installation, operational or third-party qualifications as described in Table III, step 210 can be further used to input data as to standardized or customized steps that are to be followed in performing such types of validations. This can be particularly suited where a qualification relates to a third-party standard or government regulations, and as previously mentioned in Table III, in the example of system 50 it is contemplated that system 50 must be compliant with 27 CFR Part 11. Table IV gives an example of various verification audits that can be completed to describe standardized procedures to be followed when performing a particular validation, particularly in the context of a verification audit. Where such standardized procedures can be duplicated, it is contemplated that user 22 need not re-enter each time a new project is created, but could “load” a predefined set of standardized procedures instead.

TABLE IV
Step 210
“Verification Audits”

| | | Audit Process | |
|---|---|---|---|
| Audit Type | Audit Name | Name | Procedure |
| Third Party | Must be 21 CFR | Discern invalid or | <Insert procedure |
| Qualification | Part 11 compliant | altered records | description> |
| Third Party | Must be 21 CFR | Produce human | <Insert procedure |
| Qualification | Part 11 compliant | readable | description> |
| | | documents | |
| Third Party | Must be 21 CFR | Produce electronic | <Insert procedure |
| Qualification | Part 11 compliant | readable | description> |
| | | documents | |

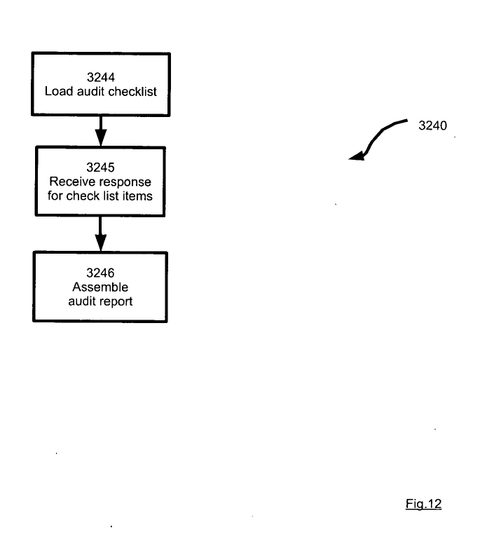

Additional types of verification audits can be added, such as Vendor Assessment audits, Installation Qualification audits, and the like. (Further detail about verification audits is discussed below with reference to FIG. 12.)

For very complex projects, further information entered at step 210 using appropriate interfaces will include an organizational structure of groups and individuals in those groups who will collectively interact with apparatus 20 and system 50 as apparatus 20 performs the remaining steps in method 200. Explained in other words, where the project involves qualifying a particularly complex or large computer system, then it is typically desired to delegate certain aspects of the validation to different individuals, and thus at step 210 an organizational structure of those individuals and the groups to which they belong will be entered for later utilization. Table V shows an example of a simple organizational structure that can be used in the validation of system 50.

TABLE V
Step 210
“Organizational Structure”

| UserID | UserName | Role | Role Responsibility |
|---|---|---|---|
| Fred | Fred Smith | Validation Team | Participates in the validation |
| | | | process of the system 50. |
| | | | (Method 200) |
| John | John Smith | End User Team | End user of system 50. Will |
| | | | work with members of |
| | | | validation team to evaluate |
| | | | operational requirements |

It should be understood that the Table V can be multi-dimensional (like other Tables describe herein). For example, Roles could map to multiple Role Responsibilities. Again, the configuration of such an organizational structure is tailored, and encoded into step 210 as it operates on apparatus 20, in order to match the complexity of the particular system being validated.

In addition to the foregoing, other information can be entered by user 22 at step 210. For example, such information can include whether the project constitutes: a retrospective validation of an existing system; a prospective validation of a new system; or a re-validation of an existing system that has already been validated, that has perhaps undergone some sort of upgrade and therefore requires re-qualification. Still further information that is typically entered at step 210 can include a network diagram, (i.e. a diagram of the type shown in FIG. 3) of the system being validated; an identification of vendors for each component (where those components are being assembled from multiple sources); an indication of which components are being purchased from third parties and which components are being developed internally by the end-user of system 50; a complete description of the process or function being automated by the system; and, an identification of the various users and user groups that will use system 50. Still further information can include a list of any relevant third-party standards and/or government regulations, and a particular description of each standard or regulation, and the impact each will have on the validation of the system.

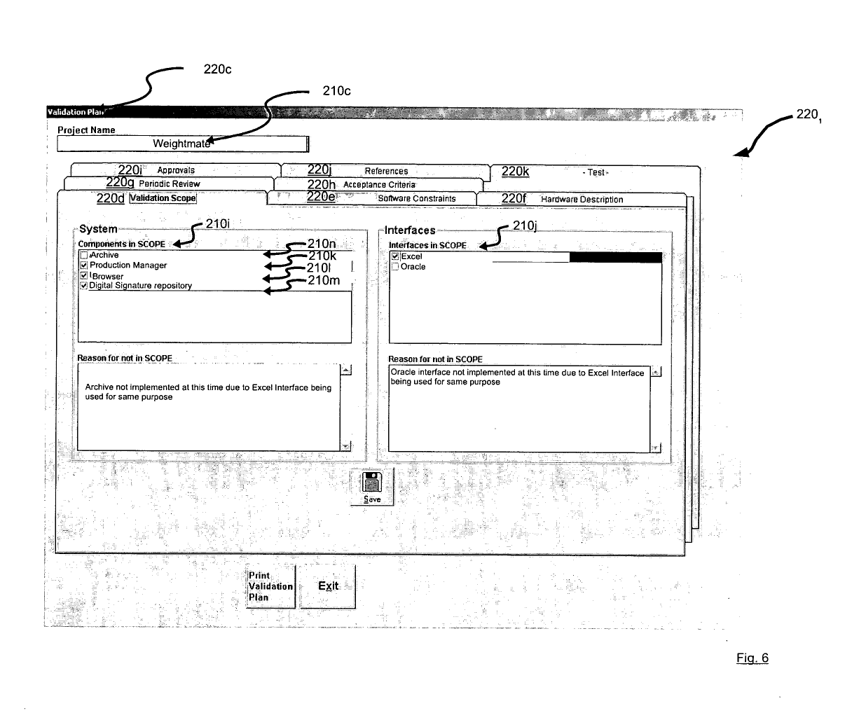

Referring again to method 200 in FIG. 2, the method advances to step 220 at which point a validation plan is generated. The validation plan is generated in part automatically from various inputs received at step 210, and from certain additional user input that is provided. Accordingly, at step 220, a user 22 of apparatus 20 will view certain data screens to verify the data thereon and/or to enter additional data into apparatus 20. FIG. 6 shows an example of a screen 220₁ that user 22 is presented with, to prompt user 22 to provide various inputs involving the creating the validation plan as part of the overall validation plan being developed at step 220. In FIG. 6, the tab labelled “Validation Scope” at reference number 220d is activated. Under tab 220d, software components 210i and interface components 210j are listed, and user 22 has the option of selecting or deselecting which components will be included in the validation plan, and an explanation given as to why a particular component is excluded. For example, the Archive Component 210n of system 50 is shown as deselected in FIG. 6, with the comment that “Archive not implemented at this time due to Excel Interface being used for same purpose”. (Recall from Table II that the “Archive” component is a repository of all logs generated during production runs of measuring masses of pharmaceutical ingredients 55, including the digital signatures attached to those logs.) Similarly, the Oracle component of the interface component 210j is shown as not being implemented at this time for the same reason.

Various other tabs 220e, 220f . . . 200j for providing data input to the Validation Plan in FIG. 6 are also shown on screen 220₁. (Tabs 220e, 220f . . . 200j are not shown in the Figures other than in FIG. 6.) Tab 220e, labelled “Software Constraints”, prompts user 22 to make text based inputs that describe known limitations and constraints to the software and/or other aspects of system 50, and/or to provide comments as to assumptions about the entire project.

Tab 220f, labelled “Hardware Description” prompts user 22 to input a description of the hardware in the system being validated. In the present example, the inputs provided under tab 220f would reflect the information included in Table I regarding scale 52 and workstation 54. In general tab, 220f is directed to ensuring that a proper description of the needed hardware (and other components such as operating software) for system 50 is provided.

Tab 220g, labelled “Periodic Review” prompts user 22 to indicate how often system 50 should be re-verfied to maintain validated status—i.e. subject again to the validation process. Tab 220h, labelled “Acceptance Criteria” prompts user 22 to provide a list of conditions to be met before system 50 is considered validated. Standard conditions would include a) meeting user requirements; b) audits having been completed; c) deviations from the conditions have been properly documented and, d) follow-up action plans have been documented.

Tab 220i, labelled “Approvals”, is a list of one or more individuals who are preparing the validation plan, and may also include a list of one or more individuals who will approve the validation plan prepared at step 220. Tab 220j, labelled “References”, is a list of manuals, literature and other documentation that accompanies system 50.

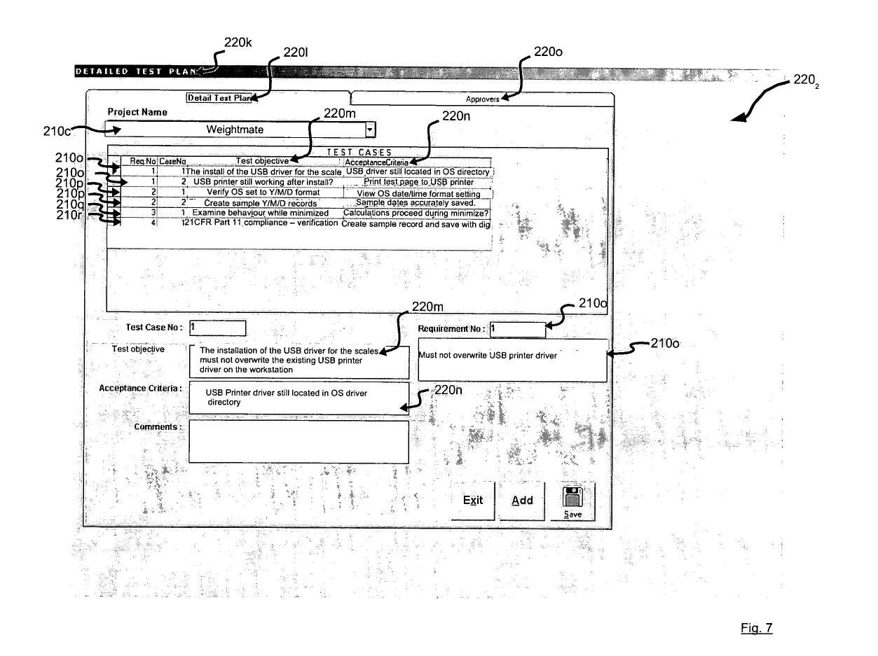

Tab 220k, labelled “Test”, when activated, opens another screen 220₂ shown in FIG. 7. Screen 220₂ includes a first tab 2201 labelled “Detailed Test Plan”. Tab 2201 prompts user 22 to provide one or more test objectives 220m and associated acceptance criteria 220n for each of the various requirements 210o, 210p, 210q, 210r that were completed on screen 210₂ of FIG. 5. The lower portion of screen 220₂ includes a detailed view of a selected record from the top portion of screen 220₂. For example, for requirement 210o “Must not overwrite USB printer driver”, two test objectives 220m are shown on screen 220₂. The first test objective 220m, shown in detail in the lower portion of screen 220₂, identifies the test objective 220m “The installation of the USB driver for the scales must not overwrite the existing USB printer driver on the workstation.” The associated acceptance criteria 220n for that test objective 220m is “USB Printer driver still located in OS driver directory?” In other words, in order to satisfy the test objective 220m “The installation of the USB driver for the scales must not overwrite the existing USB printer driver on the workstation.” The person performing the installation of “Weightmate” on workstation 54 will examine the operating system driver directory to verify that the printer driver for printer 61 has not been deleted as a result of the installation of “Weightmate” on workstation 54. A second test objective 220m for requirement 210o states that “USB printer still working after install?”, and the associated acceptance criteria 220n states that “Print test page to USB printer”. In other words, in order to satisfy the test objective 220m “USB printer still working after install?”, the installer must successfully print a test page from printer 61 once the install of “Weightmate” is complete on workstation 54. Various other test objectives 220m and acceptance criteria 220n are thus also included for requirements 210p, 210q, and 210r. It should now be understood that any test objectives 220m and acceptance criteria 220n for any requirements can be created, as desired.

Screen 220₂ includes a second tab 220o labelled “Approvers”, which includes a list of individuals who have prepared, reviewed and authorized the information entered under tab 2201 “Detailed Test Plan”.

The method then advances to step 230, at which point a computer environment for the computer system being validated is determined based on data received at steps 210 and 220. In the particular example being discussed herein, the data entered under tab 220f, “hardware description” is used to present a detailed checklist (either on monitor 28 or on some other output device of apparatus 20) of hardware components to be used to assemble system 50. Other data pertaining to the computer environment relevant to computer system 50 that was collected at steps 210 and 220 is also presented on a detailed checklist, such as the operating system for workstation 54, information about peripherals to be attached to workstation 54, including scales 52 and printer 61 is generated on the checklist. The relevant “Approvers” entered in tab 220o would then be responsible for ensuring that system 50 included all of the items on the checklist, and for inputting a confirmation into apparatus 20 that all items on the checklist are present on system 50. (Approvers can include a plurality of users that each may have different levels of security clearance to perform certain tasks associated with system 50—i.e. an individual user can be one of various types approver that is only able to execute the validation steps, but not actually change what those steps are.)

Next, at step 240, the installation of software on the computer environment determined at step 230 is validated. This step is typically performed by a user that has been granted privileges for the project, such as may be granted by a system administrator of system 20. Such a user assumes the role of user 22, working in front of apparatus 20 and beside workstation 52 and performs the installation of “Weightmate” on workstation 52 according to various prompts generated by apparatus 20 as it performs this step 240. Details of how the foregoing can be accomplished will be discussed in greater detail below. (While not discussed below, as an alternative, user 22 will work in front of workstation 52 with printed instructions generated by apparatus 20, and then return to apparatus 20 to enter responses associated with each of those instructions.)

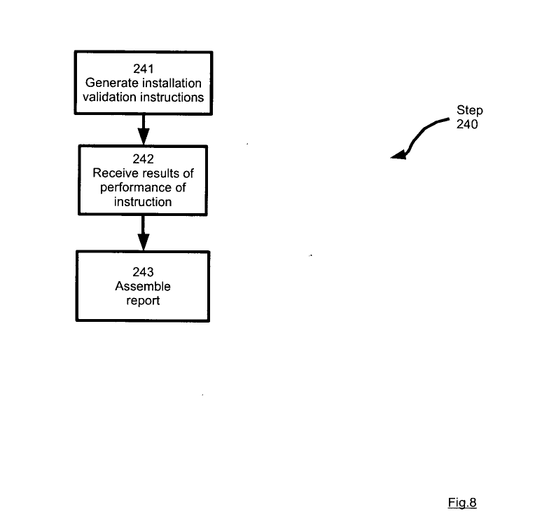

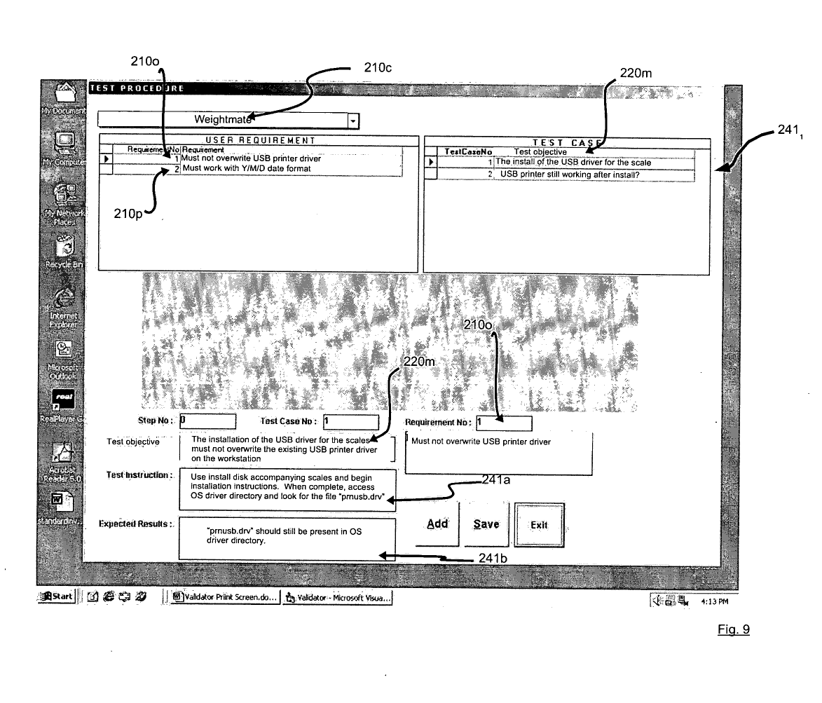

FIG. 8 shows a set of sub-steps that can be used to implement step 240. At step 241, instructions for performing the installation validation are generated. FIG. 9 shows an example of a screen 241₁ on apparatus 20 that can accompany step 241. As seen in FIG. 9, screen 241₁ includes a presentation of the installation qualifications 210o and 210p in conjunction with the test objectives 220m as previously discussed with regard to FIG. 7. User 22 can scroll up and down installation qualifications 210o and 210p and see the test objectives 220m associated with each, depending on which qualifications 210o and 210p is selected. In FIG. 9, installation qualification 210o is selected, and so the test cases 220m displayed on screen 241₁ correspond to installation qualification 210o.

At the bottom of screen 241₁, further information respective to the first test objectives 220m associated with installation qualification 210o is displayed. In particular, a test instruction 241a is provided, which in the present example states: “Use install disk accompanying scales and begin installation instructions. When complete, access OS driver directory and look for the file ‘prnusb.drv’.” In other words, the installer is to use the software installation disk for “WeightMate” that was provided with scales 52, and to install “WeightMate” using the automatic installation procedures on the installation disk. Once the installation is complete, the installer is instructed to look at the OS driver directory for workstation 54, and verify that the file called ‘prnusb.drv’ is still present. In this case, ‘prnusb.drv’ is the name of the printer driver for printer 61. Screen 2411 also includes an expected result 241b, which tells the installer that the “‘prnusb.drv’ should still be present in OS driver directory.” Thus, the installer should expect to find prnusb.drv in the OS driver directory after performing the installation of WeightMate. It should now be apparent that test instructions (like test instruction 241a) and expected results (like expected results 241b) are set up for each of the installation qualifications 210o and 210p and their associated test objectives 220m.

(While not shown in this embodiment, it should be understood that multiple test instructions, in addition to test instruction 241a can be included for each test objective.)

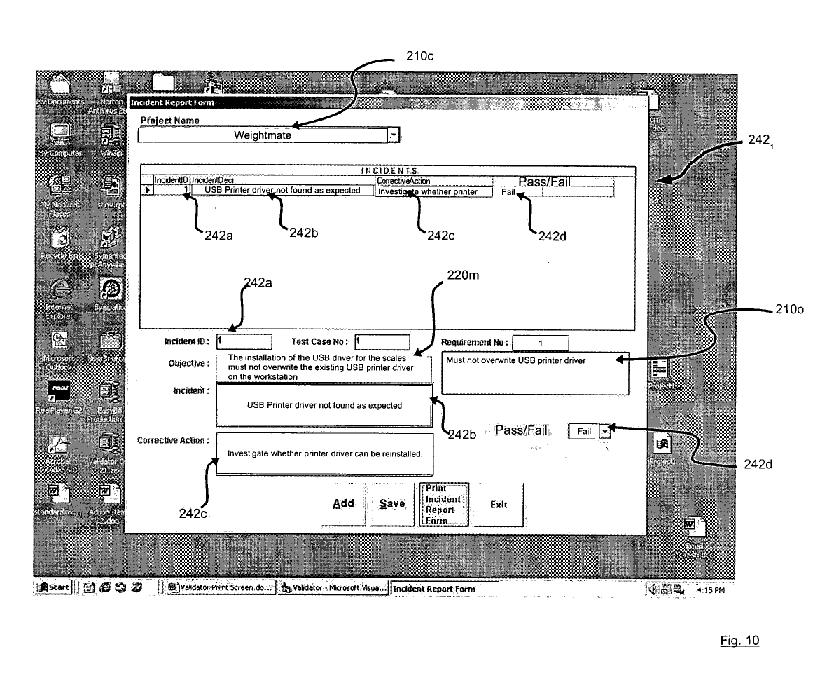

It is thus assumed that step 241 is performed in conjunction with the information generated on screen 241₁ until all test instructions are completed. Then, at step 242, the results of what was performed at step 241 is received by inputting those results into apparatus 20. FIG. 10 shows an example of a screen 242₁ where such input can be performed. The top portion of screen 242₁ includes an area where a number of incidents pertaining to particular results obtained when various test objectives (like test objective 220m) are performed. The bottom of screen 242₁ includes a detailed view of each of those incidents. An incident includes an incident ID 242a, which is a unique identifier or index number for a particular incident. Each incident also includes an incident description 242b, that details what happened. The incident also includes a proposed corrective action 242c, in the event of a failure of a given test instruction, and a “pass/fail” status 242d. (The “fail” status may be updated at a later time to a “pass” status if the correction was successful.)

At step 243, information from steps 241 and 242 is assembled into a coherent report for later review and for auditing purposes. Where there are number of “fails” in various status 242d, then the report will also be used to detail those failures and the proposed corrective actions. (Such reports are also generated for failed verification audits, where such audits are used—the details of such audits will be discussed in greater detail below with reference to FIG. 12.)

Referring again to FIG. 2, the method then advances to step 250 and then to 260. It should now be apparent that steps 250 and 260 can be performed in substantially the same manner as step 240, but with an emphasis on operational qualifications at step 250, and on third-party qualifications at step 260. Thusly, at step 250 validations for operational requirement 210q would be carried out, while at step 260, validations for third-party qualifications 210r would be carried out. Accordingly, the exact operation of step 250 and 260 would be implemented using an appropriately modified version of the foregoing description of step 240.

When the method in FIG. 2 reaches step 270, a complete validation report is generated. Thus, the report assembled at step 243, and the corresponding reports that are assembled from steps 250 and 260 are assembled into one complete verification report that details all aspects of the validation process of system 50. At step 280, a determination is made as to whether the system has been validated based on report at step 270. If the tests from steps 240-260 all have a “pass” status (or their “fail” status is overridden for some acceptable reason), then the apparatus 20 advances to step 300 and generates a final report to user 22 that system 50 can be released for use as a validated computer system. (Again, where verification audits are used, (discussed with reference to FIG. 12 below), then the success or failure of those audits will also affect validation at this stage.) However, if it is determined at step 280 the system is not validated, then the method advances to step 290 so corrective action can be taken, and the method returns to step 210 (or such other step as may appropriate according to where “fail” statuses occurred) so that the validation steps can be performed again. (Where verification audits are also performed (as will be discussed in greater detail below with reference to FIG. 12), then such verification audits will also be reflected in reports at step 270, and the success or failure of those audits will influence whether the system is ultimately validated, or not.)

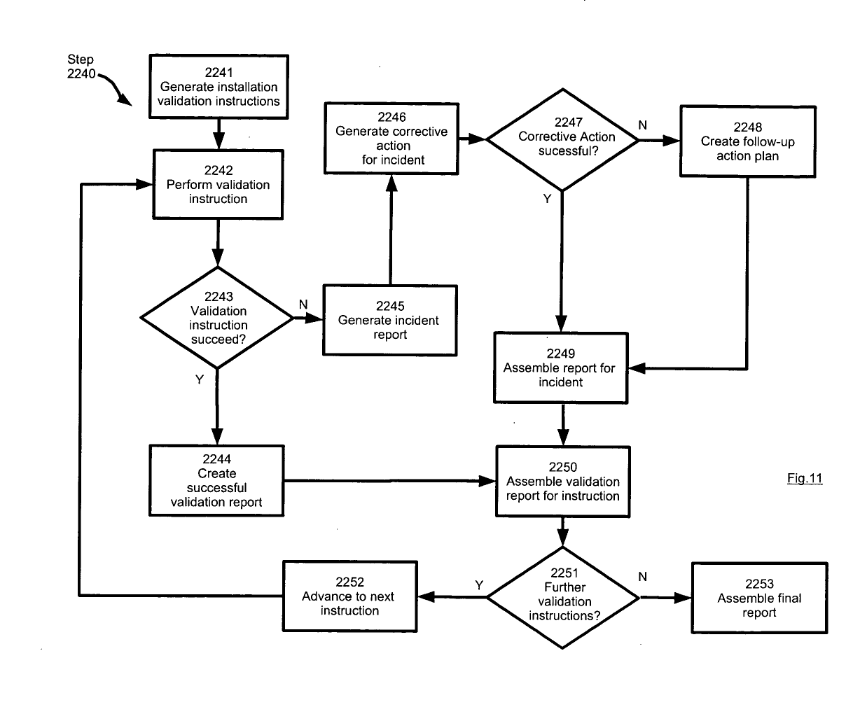

Step 240 in method 200 can be performed in different ways, other than the substeps discussed herein with reference to FIG. 8. For example, FIG. 11 shows a method 2240, which can be used to perform step 240 of FIG. 2. At step 2241, a set of installation validation instructions are generated, much as they would be generated using step 241 discussed in FIG. 8. (For example, test instruction 241a of FIG. 9 could be a validation instruction generated at 2241). The method advances to step 2242, at which point the first validation instruction generated at step 2241 is performed. At step 2243, it is determined whether the validation instruction performed at step 2242 succeeded.

Thus, if, when the particular installation instruction was performed, a successful result was achieved, then the individual performing the installation would provide input to apparatus 20 that the installation instruction performance was successful and the method advances to step 2244, where a report is created that reflects that the particular installation instruction was successful.

However, if an unsuccessful result was achieved at step 2243, then the method advances to step 2245 and an incident report is generated. (Such an incident report could be of the form, for example of input in the form of incident description 242b of FIG. 10). Next, at step 2246, a corrective action is generated based on the incident report from step 2245. (Such a corrective action could be of the form of proposed action plan 242c).

Next, at step 2247, it is determined whether the corrective action was successful. Various reasons can arise whereby it may be determined that the corrective action was unsuccessful. For example, the corrective action at step 2246 may actually require a “patch” to a particular piece of software or the operating system being installed, and thus no successful corrective action may be possible until such a patch is completed, and thus the determination at step 2247 would be that the corrective action was unsuccessful. Thus, where at step 2247 it is determined that the corrective action is unsuccessful, the method advances to step 2248, where a follow-up action plan is created that reflects that the corrective action was not successful, and that further follow-up action is required and/or that a particular component of system 50 (or whatever system is being validated) is unusable until the validation instruction at step 2242 can be performed successfully. The follow-up action plan thus documents a complete set of details about why a particular validation instruction failed, and which will eventually appear on a final validation report that is generated at step 270 in method 200 and ultimately affect whether the overall system is considered validated at step 280.

If, however, at step 2247 the implementation of the corrective action was successful, then the method advances directly to step 2249 where a report that summarizes the events for a particular incident is generated, and in particular, summarizes what has occurred from step 2245 onwards. The report generated at step 2249 thus documents a complete set of details about how a particular validation instruction initially failed at step 2243, but which was ultimately successful through a corrective action, and this information will also ultimately appear on the final validation report that is generated at step 270 in method 200, and ultimately serve as part of the record reflecting why (or why not) the overall system was considered to have been validated at step 280.

Step 2249 can also be reached via step 2248. In this event the report includes a summary of what has occurred from step 2245 onwards, and also includes why the corrective action was unsuccessful at step 2247, and details the follow-up action plan generated at step 2248. Again, the report generated at step 2249 thus documents a complete set of details about how particular validation instruction initially failed at step 2243, but which was ultimately successful through a corrective action, and this information will also ultimately appear on the final validation report that is generated at step 270 in method 200, and ultimately serve as part of the record reflecting why (or why not) the overall system was considered to have been validated at step 280.

Step 2250 is reached via either step 2249 or step 2244, and in either event, reflects an overall report about the success, failure and reasons therefor as pertains to the particular validation instruction that was performed that step 2242.

At step 2251, it is determined whether all of the validation instructions generated at step 2241 were performed, and, if further instructions are to be performed, the method advances to step 2252, where the next validation instruction is queued and the method returns to step 2242 and the remainder of the process begins anew. However, if there are no further instructions to be performed, then the method advances to step 2253 and a final report assembling all of the validation reports generated at step 2250 is compiled for eventual use at step 270 of method 200 and to contribute towards the determination at step 280 as to whether to validate system 50 (or such other system being validated).

Thus, when using method 2240 to perform step 240, it is contemplated that step 290 would be used to deal with the reports generated at step 2248 that accumulated to prevent the validation of the entire system. Thus, for example, if a “patch” was required to a piece of software as determined in a report generated during a particular pass through step 2248, then the implementation of that patch could be the particular modification to the system that is effected at step 290.

It will now be apparent that steps 250 and 260 can also be so varied to utilize the method in step 2240, or its variations.

As a further enhancement to method 200, it is contemplated that one or more audits can be implemented in association with one or more of the steps in method 200. An audit is typically comprised of a plurality of high level guiding principles or best practices that are applicable to any system that is being validated. Elements of an audit are typically expressed in form of a checklist to which a user would be prompted to provide individual responses for each item on the checklist. The actual flow of how the items on the checklist are addressed could be as simple as step 240 shown in FIG. 8, or in a more complex manner according to the method 2240 in FIG. 11. FIG. 12 shows a method 3240 which can be performed in addition to step 240 of FIG. 8, and/or method 2240, or method 3240 can be performed in lieu of both where it is an appropriate way to conduct a particular validation. At step 3244, an audit checklist (for example, the checklist in Table IV) is loaded from a storage device on apparatus 20, and that audit checklist becomes associated with a particular project. At step 3245, user 22 is prompted to provide a response for each item on the checklist, as to whether that particular item has been addressed or not. Particularly, where a particular item on the checklist fails, user 22 is prompted to provide a reason as to why the failure occurred, and can also include what action should be taken. At step 3246, an audit report checklist is assembled, which is ultimately destined for integration into the validation report to be generated at step 270 of method 200. Examples of items that may appear in an audit checklist are shown in Table VI.

TABLE VI
“Exemplary Audit Checklist”

Check list Item
Is there sufficient power available to provide power to the system?
Does the system have UL or CSA electrical safety approvals?
Have all Operating System patches been installed?
Has a virus scan been performed on system installation?

Additional audit checklist items will occur to those of skill in the art, and can be tailored to installation validations at step 240, to operational validations at step 260, and/or to third-party requirement verifications at step 260. In particular, it is contemplated that method 3240 would be performed in addition to step 240 of FIG. 8, or method 2240 of FIG. 11. Such addition of method 3240 would help to ensure that the manually generated validation instructions of step 241 and step 2241 are sufficiently capturing all potential issues with a given validation, particularly in relation to issues that are substantially universal to all validation projects. Thus, such audit items may or may not be superfluous to certain validation instructions, but will in any event serve as a supplementary check that no major issues were missed when the validation instructions were generated. While not included in the present embodiment, in other embodiments other types of audit checklists can include vendor assessment, system definition, system design, system implementation, installation qualification, operational qualification, performance qualification, 21 CFR Part 11, change control, certification, periodic review and revalidation.

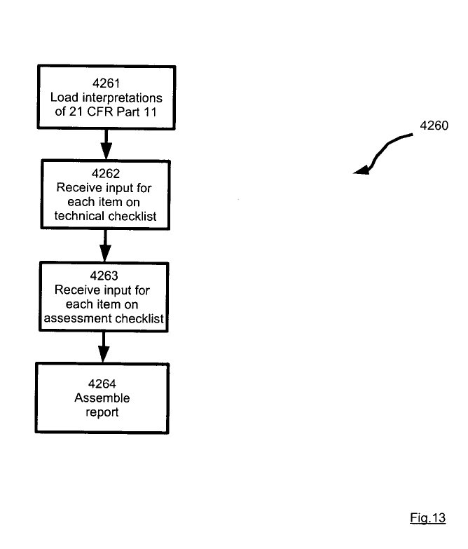

Of particular mention, at step 260 it is contemplated that apparatus 20 would have a knowledge base of third-party qualifications, including third-party qualification 210r relating to the industrial standard or government regulation, and in a particular embodiment, to 21 CFR Part 11. The knowledge base includes interpretation of the relevant sections of 21 CFR Part 11 as to how they apply to validating a computer system in a pharmaceutical manufacturer or certain other types of healthcare applications. Thus, as a still further variation to method 200, it is contemplated that where step 260 is directed to fulfilling obligations under 21 CFR Part 11, the method 4260 of FIG. 13 would be used to implement step 260. At step 4261, approved interpretations of legal requirements under 21 CFR Part 11 is loaded from a storage device on apparatus 20, which are reflected in the form of a checklist. In particular, such a checklist will include a technical checklist and an assessment checklist. The technical checklist is directed to a series of technical requirements that a vendor (or other provider) of the system being validated is required to meet. For example, Section 11.10(b) of 21 CFR Part 11 includes a particular legal requirement that can be interpreted to mean, “Can system generate accurate, complete copies of records in electronic and human readable format?”. The assessment checklist is directed to whether the system meets its requirements under 21 CFR Part 11, and will typically include a verification of the technical checklist. Thus, the method advances through steps 4262 and 4263, which are performed in much the same manner as step 3245 of method 3240 in FIG. 12. Similarly, the assembly of the report at step 4264 is performed in much the same manner as step 3246. Again, the report at step 4264 is ultimately reflected in the validation report at step 270, and the success or failure meeting checklist items at steps 4262 and 4263 forms part of the ultimate decision at step 280 as to whether the system is validated or not.

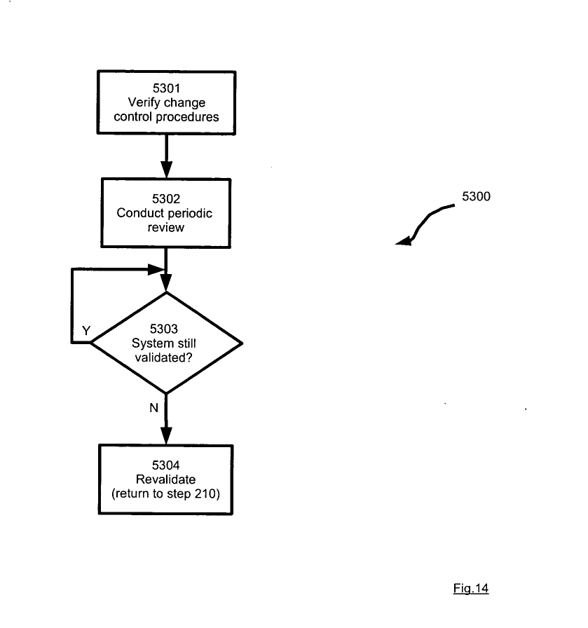

It is also to be noted that step 300 can be performed as a number of substeps, as shown as method 5300 in FIG. 14, (essentially as a type of verification audit, similar in concept to the method 3240 in FIG. 12, but implemented in the manner shown in method 5300). At step 5301, change control procedures for the now-validated system are verified. Such change control procedures can include any standard operating procedure for adding new versions of software, applying patches, updates, hardware upgrades or the like.

At steps 5302 and 5303, a review is conducted on a periodic basis to evaluate whether the system remains in a validated state. In a particular example, it is contemplated that uncontrolled changes to system 50 (or the like) were effected thus failing the verification performed at at step 5301. In this case, at step 5303, it would be determined that the system is no longer validated, and the method would advance to step 5304 where the system would be revalidated, perhaps using method 200 or an appropriate variation thereof. In any event, such a revalidation would typically be substantially the same as the validation method to actually validate the system in the first instance.

Referring now again to step 270, it is now to be reiterated that the foregoing variations, when incorporated into method 200, will ultimately reflect on the reports that are generated at step 270. Table VII shows a list of reports that can be generated when the foregoing variations are incorporated into method 200. Other reports can also be added according to the particular data collected.

TABLE VII
Validation Report Contents

| Report Name | Description |
|---|---|
| Testing Summary: | Includes at least the following information for |
| | tests conducted: test case unique |
| | identifier, test objective, acceptance criteria, |
| | criteria, pass or fail, and any comments |
| Incident Reports: | All incidents for tests conducted, particularly for |
| | failed tests. |
| Action Reports: | All actions taken and/or proposed courses of |
| | action to be taken, particularly for failed tests. |
| Traceability Matrix: | Lists the test cases which cover the user |
| | requirements (i.e. Requirement number, |
| | Requirement description, test case unique |
| | identifier, and test case objective) |
| Audit Reports: | All gaps for all validation phases (i.e. all |
| | incidents or verification audits resulting in a non- |
| | pass result). |
| Validation Plan: | Details of plan generated at step 220. |
| Validation Summary | Overall summary of the foregoing. |
| Report: | |

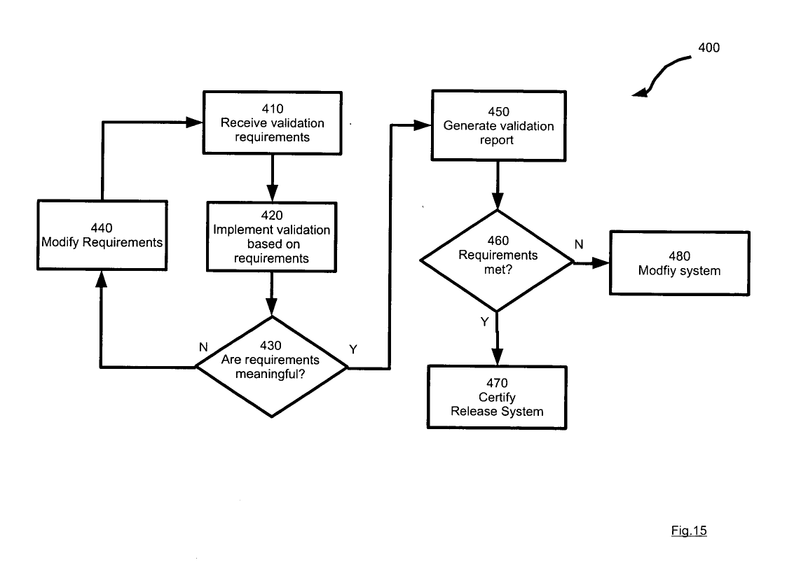

Another embodiment of the invention is shown as method 400 in FIG. 15 which can also be used to validate a system such as system 50. Method 400 is typically computer implemented on an apparatus such as apparatus 20. At step 410, a set of validation requirements for a particular system are received. Such validation requirements can be manually entered hardware requirements, user requirements, test objectives, test instructions, expected results, and any other type of user defined validation requirement for a particular system. Validation requirements can also be retrieved from one or more databases of audit checklists, such as vendor requirement checklists, 21 CFR Part 11 checklists, and any other type of checklist of requirements for a particular system that would have generic or universal application to the validation of one or more systems using method 400. Thusly, such validation requirements may be respective to installation validations, operation validations, performance validations, third party requirement validations or the like.

At step 420, the validation of the system is implemented using the requirements received at step 410. Thus, for example, where a set of test instructions were received, then a corresponding action is performed to implement that requirement. Apparatus 20 will thus generate either a hard copy or soft copy set of instructions and/or test procedures for performing the implementation that are based on the requirements from 410. Also as part of step 420, the user of apparatus 20 is prompted to provide responses that reflect whether a particular test procedure for implementing the validation was successful, or unsuccessful, and if unsuccessful, why.

At step 430, it would be determined whether the unsuccessful validation implementations of step 420 occurred as a result of requirement from step 410 that was not meaningful, and if unmeaningful, the method would advance to step 440 where the requirement would be modified and then performed as the method returned to step 410. An unmeaningful requirement can arise for a variety of reasons. For example, where a software patch is required in order use a particular feature of the system, and yet that particular feature of the system is not actually needed, then the requirement for that feature can be modified, by changing the requirement to disable that particular feature during installation. Of particular note, however, is that all aspects of the performance of steps 410-440 are carefully logged for eventual reporting.

Thus, at step 450, a validation report is generated that corresponds to each requirement, and thus also includes information as to unsuccessful aspects of the performance of the validation, modifications to validation requirements that were made, and so forth. The report at step 450 is detailed and intended to accompany the system once it is validated for later external auditing purposes, such as audits that may be conducted by government authorities wishing to verify compliance of the system with 21 CFR Part 11.

Accordingly, at step 460, it is determined whether the requirements for validating the system have been met, and if so, the method advances to step 470 where the system is certified for release. If not, the method advances to step 480 where the system is modified, at which point steps 410-460 can be re-performed until the system is eventually validated.

While the foregoing embodiments herein are directed to validations of computer systems in the pharmaceutical industry, it is to be understood that these embodiments can be modified for use in other industries, such as the health care industry, or nuclear industry and/or any other type of industry where computer system validation is required. It is also to be understood that the embodiments herein can be modified for validation of equipment, machinery, processes such as cleaning services, and need not be applied simply to validation of computer systems.

It is to be reiterated that the various data shown in Tables herein are exemplary only, to assist in explaining various embodiments, and do not constitute any specific manner or mode of operation in which the present invention is particularly limited.

In another embodiment of the invention, a user-login screen is added to the method shown in FIG. 2 and/or the method shown in FIG. 15. The user-login screen includes the requirement that the user enter in a user code, in addition to a user-id. The user code is a unique code that is generated for that user, once that user has successfully completed an electronically delivered training course for the use of the method shown in FIG. 2 (and/or the method shown in FIG. 15.) The user code verifies that a particular user has completed the necessary training to use the method shown in FIG. 2 (and/or the method shown in FIG. 15.) The database of user codes in the user-login screen is thus linked to the electronically delivered training course, so that entered user-codes in the user-login screen can be cross referenced to user-codes that are generated by the electronically delivered training course, once the electronically delivered training course is successfully completed by the particular user.

While only specific combinations of the various features and components of the present invention have been discussed herein, it will be apparent to those of skill in the art that desired subsets of the disclosed features and components and/or alternative combinations of these features and components can be utilized, as desired. For example, it is to be understood that additional steps to method 200 can be added, or steps that are superfluous for certain systems can be removed, and/or that the steps of method 200 can be performed in different sequences. Examples of additional validation steps can include a detailed functional specifications, network system design, or a vendor audit. Such a vendor audit can be performed using an appropriate variation of method 3240 in FIG. 12, where the audit checklist would include a list of questions directed to assessing whether a vendor met certain requirements such as whether the vendor had a quality procedure that it implemented, or whether the vendor directly employed its employees or relied heavily on outsourcing.

Another type of validation that can be performed is a performance validation, which is typically performed when the system is actually in production, whereas the installation and operation validations (i.e. steps 240 and 250) are usually performed pre-production. The performance validation will typically relate to how well the system operates (i.e. efficiency, speed, reliability, etc.), whereas operational validations are typically directed to whether the system is even capable of performing the required tasks.

Thus, as previously mentioned, the exact steps of method 200 can vary according to the particular type of system being validated. It is also thus contemplated that, as part of step 220, the particular steps in method 200 to actually be performed (i.e. whether installation validation (step 240), operational validations (step 250), third-party compliance verifications (step 260), and other validations such as performance validations, system specification) can be dynamically loaded according to the type of project requirements received at step 210. Table VIII shows a list of categories of systems, and an accompanying exemplary list of validation approaches that can accompany such categories of systems.

TABLE VIII

| Category | Included validation approaches |
|---|---|
| Operating Systems | Installation Validation (Step 240) and Operation |
| | (Step 250) |
| Custom Built Systems | Installation (Step 240), Operation (Step 250) and |
| | detailed functional specifications |
| Standard Software | Installation (Step 240), Operation (Step 250), 21 |
| Packages | CFR Part 11 (Step 260) |

Again, the items in Table VIII are merely exemplary as specific choices for particular categories of systems, and other categories and/or other validation types can be used. It is also contemplated that user 22 can manually select the various validation types to include, and/or can include additional validation types, and/or delete certain validation, thereby overriding the specific choices that are presented.

Where there are no third party requirements with which a particular system must comply, then step 260 of method 200 can be omitted, and the corresponding components of the validation plan generated at step 220 can be omitted. Other steps in method 200 can be omitted where appropriate to a particular validation project.

Table 1×shows a more detailed matrix of categories and validation approaches that can be implemented according to other embodiments of the invention. An “X” denotes that a particular approach is adopted for that category of system. (Note the axes in Tables VIII and IX are transposed.)

TABLE IX

| | Category | | | | |
|---|---|---|---|---|---|
| | | | | | Category 5 |
| | | | Category 3 | Category 4 | (Custom |
| | Category 1 | Category 2 | (Standard | (Configurable | Built or |
| | (Operating | (Instruments & | Software | Software | Bespoke |
| Approach | Systems) | Controllers) | Packages) | Packages) | Systems) |
| Validation | | | X | X | X |
| Plan | | | | | |
| User | | | X | X | X |
| Requirements | | | | | |
| Functional | | | | | X |
| Definition | | | | | |
| System | | | | | X |
| Design | | | | | |
| System | | | | | X |
| Implementation | | | | | |
| Vendor | | | | X | |
| Assessment | | | | | |
| Installation | X | X | | X | X |
| Validation | | | | | |
| Operational | | | X | X | X |
| Validation | | | | | |
| Performance | | | X | X | X |
| Validation | | | | | |
| 21 CFR Part | | | X | X | X |
| 11 Validation | | | | | |
| Periodic | | | X | X | X |
| Review | | | | | |
| Revalidation | | | | X | X |
| Certification | | | X | X | X |
| Change | X | X | X | X | X |
| Control | | | | | |

The present invention provides a novel method for validating computer systems, in particular for validating computer systems for use in a pharmaceutical industry. The method is computer based, and in at least one embodiment includes steps of gathering information about project for a particular computer system, generating a validation plan for that system, including a plurality of tests to be conducted on the system. The method also includes a steps for presenting the tests and gathering responses, and organizing and presenting an overall report regarding the success or failure of those tests. The method can particularly useful for validating computer systems subject to third-party requirements, such as 21 CFR Part 11. The method can also provide for providing one consistent validation procedure to be applied to the validation of multiple rollouts of identical systems within different areas of an organization. Thus, where a company purchases multiple systems for installation at different locations, a validation project developed for the first system can be used on the other systems to ensure that the validation procedures being employed are consistent. The method is also advantageous in particularly large and complex validation projects for hundreds or thousands of requirements for validation, and by ensuring that for each validation requirement, feedback is provided and recorded for how or whether a particular validation requirement was achieved, and by generating a detailed report that reflects each and every requirement and the feedback associated therewith.

The above-described embodiments of the invention are intended to be examples of the present invention and alterations and modifications may be effected thereto, by those of skill in the art, without departing from the scope of the invention which is defined solely by the claims appended hereto.

1. A computer-implemented method of validating a computer system comprising the steps of:
(i) receiving data representative of a plurality of requirements for said computer system;
(ii) generating a validation plan based on said received data;
(iii) determining a computing environment appropriate to said computer system based on said received data;
(iv) generating a plurality of tests to be performed during an implementation of said validation plan;
(v) presenting said tests to a user as part of said implementation;
(vi) receiving responses from said user as to a status of said tests;
(vii) generating a validation report based on said responses;
(viii) presenting a non-validation message if said validation report indicates said system failed one or more of said tests;
(ix) presenting a validation message if said validation report indicates said system meets said tests; and,
(x) repeating one or more of the foregoing steps until said validation report indicates said system meets said tests.

2. A computer-implemented method of validating a computer system comprising the steps of:
receiving a plurality of validation requirements for said computer system;
receiving data representative of the results of performing each validation requirement, said results including whether a particular requirement was achieved and exception reports for each requirement that was not achieved; and,
generating a report for each of said requirements, said report including a message indicating whether said system is validated if a defined set of said requirements are achieved.

3. The method according to claim 2 wherein said computer system is a computer system used in the pharmaceutical industry.

4. The method according to claim 2 wherein said computer system is a computer system used in the health care industry.

5. The method according to claim 2 wherein said validation requirements include at least one of a installation qualification, operational qualification, performance qualification, a third-party qualification.

6. The method according to claim 4 wherein said third-party qualification is based on 21 CFRPart 11.

7. The method according to claim 6 wherein said installation qualification, said operational qualification, said performance qualification, and said third-party qualification each include at least one of a hardware requirement, a user requirement, a test objective, and a test instruction.

8. The method according to claim 6 wherein said validation requirement further includes an audit respective to said installation qualification, said operational qualification, said performance qualification, and said third-party qualification.

9. The method according to claim 8 wherein said audit is comprised of predefined checklist reflecting best practices applicable to an identifiable type of said system.

10. The method according to claim 2 wherein said report indicates that said requirements are not achieved unless an affirmative response that each requirement was achieved has been received.

11. The method according to claim 2 comprising the additional step of presenting a report summarizing each of said requirements.

12. An apparatus for validating a computer system comprising:
an input means for receiving a plurality of validation requirements for said computer system;
said input means additionally for receiving data representative of the results of performing each validation requirement, said results including whether a particular requirement was achieved and exception reports for each requirement that was not achieved; and,
a processing means for generating a report for each of said requirements, said report including a message indicating whether said system is validated if a defined set of said requirements are achieved.

13. The apparatus according to claim 12 wherein said computer system is a computer system used in the pharmaceutical industry.

14. The apparatus according to claim 12 wherein said computer system is a computer system used in the health care industry.

15. The apparatus according to claim 12 wherein said validation requirements include at least one of a installation qualification, operational qualification, performance qualification, a third-party qualification.

16. The apparatus according to claim 15 wherein said third-party qualification is based on 21 CFR Part 11.

17. The apparatus according to claim 16 wherein said installation qualification, said operational qualification, said performance qualification, and said third-party qualification each include at least one of a hardware requirement, a user requirement, a test objective, and a test instruction.

18. The apparatus according to claim 16 wherein said validation requirement further includes an audit respective to said installation qualification, said operational qualification, said performance qualification, and said third-party qualification.

19. The apparatus according to claim 18 wherein said audit is comprised of predefined checklist reflecting best practices applicable to an identifiable type of said system.

20. The apparatus according to claim 12 wherein said report indicates that said requirements are not achieved unless an affirmative response that each requirement was achieved has been received.

21. The apparatus according to claim 12 comprising additional means for presenting a report summarizing each of said requirements.

22. A readable media storing a set of instructions executable on a computing device to perform the following steps:
receiving a plurality of validation requirements for said computer system;
receiving data representative of the results of performing each validation requirement, said results including whether a particular requirement was achieved and exception reports for each requirement that was not achieved; and,
generating a report for each of said requirements, said report including a message indicating whether said system is validated if a defined set of said requirements are achieved.

23. A method of restricting access to a computing apparatus comprising the steps of:
delivering a computer-based training session to a user, said session for instructing said how to operate said apparatus;
generating a unique user code respective to said user provided said user successfully completes said training session;
presenting a user-login dialogue on said apparatus, said dialogue requesting an identification of said user and said user code;
allowing access to said computing apparatus if a received identification and a received user code match said user and said user code and otherwise refusing access to said computing apparatus.
